(19) United States
(12) Patent Application Publication
(10) Pub. No.: US 2007/0029932 A1
(43) Pub. Date: Feb. 8, 2007

(54) Display panel module and manufacturing method thereof

(75) Inventors: Young Sung Kim, Yongin-si (KR); Kyung Ku Kim, Seoul (KR); Hong Rae Cha, Seoul (KR); Myeong Soo Chang, Oeiwhang-si (KR); Byung Gil Ryu, Seoul (KR)

Correspondence Address: FLESHNER & KIM, LLP, P.O. BOX 221200, CHANTILLY, VA, 20153, US

(73) Assignee: LG ELECTRONICS INC.

(21) Appl. No.: 11/580,123

(22) Filed: Oct. 13, 2006

Related U.S. Application Data
(63) Continuation of application No. 10/832,456, filed on Apr. 27, 2004.

(30) Foreign Application Priority Data
Apr. 28, 2003 (KR) 2003/26739

(51) Int. Cl. H01J 17/49

(52) U.S. Cl. 313/582; 313/587

(57) ABSTRACT

Disclosed is a display panel module having a black panel adequate for a film type front filter, and a manufacturing method thereof The display panel module includes a display panel; a black frame formed on a front surface of the display panel to define an effective screen area; and a front filter formed on the front surface of the display panel on which the black frame is formed, to shield electromagnetic waves and for optical correction.

This application is a Continuation of U.S. application Ser. No. 10/832,456 filed Apr. 27, 2004. The disclosures of the previous application are incorporated by reference herein.

### BACKGROUND OF THE INVENTION

1. Field of the Invention

The present invention relates to a display panel module having a black panel adequate for a film type front filter, and a manufacturing method thereof.

2. Discussion of the Background Art

In general, PDPs display an image by controlling gas discharge time of each pixel on the basis of digital video data. Typical examples of these PDPs are AC PDPs, as shown in FIG. 1. The AC PDP includes three electrodes and is driven by an AC voltage.

FIG. 1 is a perspective view of a related art AC PDP 30. More particularly, FIG. 1 illustrates the structure of a discharge cell corresponding to a sub-pixel.

As shown in FIG. 1, the discharge cell is divided into an upper plate 15 and a lower plate 25. The upper plate 15 includes an upper substrate 10 where a sustain electrode pair 12A and 12B, an upper dielectric layer 14, and a protective film 16 are formed in sequence. The lower plate 25 includes a lower substrate 18 where a data electrode 20, a lower dielectric layer 22, a barrier rib 24, and fluorescent layers 26 are formed in sequence.

The upper substrate 10 and the lower substrate 18 are spaced out in parallel by the barrier rib 24.

The sustain electrode pair 12A and 12B respectively includes a transparent electrode for transmitting visible rays, and a metal electrode for compensating resistance of the transparent electrode. The transparent electrode is relatively wider than the metal electrode. The sustain electrode pair 12A and 12B includes a scan electrode 12A and a sustain electrode 12B. The scan electrode 12A provides scan signals for determining data supply time and sustain signals for sustaining the gas discharge. On the other hand, the sustain electrode 12B mainly provides sustain signals for sustaining the discharge.

The upper dielectric layer 14 and the lower dielectric layer 22 are piled up with charges from the gas discharge. The protective film 16 protects the upper dielectric layer 14 from damages caused by a sputtering of plasma and thus, extends lifespan of the PDP and improves the emission efficiency of secondary electrons. The protective film 16 is usually made from magnesium oxide (MgO). The dielectric layers 14 and 22 and the protective film 16 lower an externally applied discharge voltage.

The data electrode 20 is formed at right angles to the sustain electrode pair 12A and 12B. The data electrode 20 provides data signals for selecting cells to be displayed.

The barrier rib 24 together with the upper and lower substrates 10 and 18 create a discharge space. The barrier rib 24 is formed in parallel with the data electrode 20, and prevents ultraviolet rays generated by the gas discharge from leaking to the adjacent discharge cells.

The fluorescent layer 26 is applied to the surface of the lower dielectric layer 22 and barrier rib 24, and generates one of visible rays in red, blue, or blue. The discharge space is filled with inert gases including He, Ne, Ar, Xe, and Kr, or different compositions of the inert gas mixtures, or Excimer gas for generating ultraviolet rays by the gas discharge.

Thusly structured discharge cell is selected by an opposing electrode discharge between the data electrode 20 and the scan electrode 12A, and sustained by a surface discharge between the scan electrode 12A and the sustain electrode 12B. Therefore, the fluorescent layer 26 is excited by ultraviolet rays generated during the sustain discharge, and visible rays are emitted to the outside of the cell. In this case, the discharge cell controls the cell's discharge sustain period, namely frequency of the sustain discharge, according to video data, and emits a light at a gray scale level.

FIG. 2 is a schematic perspective view of a PDP set including the PDP 30 of FIG. 1.

As shown in FIG. 2, the PDP set includes a case 60, a printed circuit board 50 (hereinafter, it is referred to as “PCB”) housed in the case 60, a PDP 30, a glass type front filter 40, and a cover 70 connected to the case 60 and encompassing the glass type front filter 40.

As discussed before with reference to FIG. 1, the PDP 30 includes an upper plate 15 and a lower plate 25 being connected to each other.

The PCB 50 disposed on the rear surface of the PDP 30 includes a plurality of driving and control circuits for driving the sustain electrode pair 12A and 12B and the data electrode 20 formed on the PDP 30. Situated between the PCB 50 and the PDP 30 is a heat radiation plate (not shown) for radiating heat emitted from the PDP 30 and the PCB 50.

The glass type front filter 40 shields electromagnetic waves generated from the PDP 30 towards the front surface, prevents external light reflection, blocks near-infrared rays, and corrects colors. To this end, the glass type front filter 40 includes, as shown in FIG. 3, a first antireflection coating 44 attached to a front surface of a glass substrate 42; and a black frame 45, an EMI shielding film 46, a NIR (near infrared ray) blocking film 48, a color correcting film 52, and a second antireflection coating 54, where the black frame 45, the EMI shielding film 46, the NIR blocking film 48, the color correcting film 52 and the second antireflection coating 54 are layered in cited order on the rear surface of the glass substrate 42.

The glass substrate 42 is made from a reinforced glass to support the glass type front filter 40 and to protect the front filter 42 and the PDP 30 from damages caused by external impacts.

The first and second antireflection coatings 44 and 54 prevent incident light rays from outside from reflecting back to the outside and thus, improve contrast effects.

The black frame 45, as shown in FIG. 4, frames the outline of the PDP 30. The black frame 45 defines an effective screen area and makes the screen outline stood out relatively. To form the black frame 45, black ceramic is printed on the rear surface of the glass substrate 42 and then undergoes a thermal treatment process to be fixed thereon.

The EMI shielding film 46 absorbs electromagnetic waves generated from the PDP 30, and shields the emission of the electromagnetic waves to outside.

The NIR blocking film 48 absorbs near infrared rays at a wavelength band of 800-1000 nm that are generated from the PDP 30, and blocks the emission of the near infrared rays to outside. This is how infrared rays (approximately 947 nm) generated from a remote controller are normally input to an infrared ray receiver built in the PDP set.

The color correcting film 52 contains a color dye to adjust or correct colors, and consequently improves color purity. These films 44, 46, 48, 52, and 54 are adhered to the glass substrate 42 through an adhesive or glue.

The case 60 protects the PCB 50, the glass type front filter 40 and the PDP 30 from external shocks, and shields electromagnetic waves emitted from side and rear surfaces of the PDP 30. Also, to ensure that the glass type front filter 40 is separated from the PDP 30, the case 60 is electrically connected to the EMI shielding film 46 of the glass type front filter 40 through a support member (not shown) that supports from the rear surface of the case 60. Therefore, the case 60 and the EMI shielding film 46 of the glass type front filter 40 are both earthed to a ground voltage and absorb electromagnetic waves emitted from the PDP 30 and discharge them. This is how the emission of the electromagnetic waves to outside is blocked.

Lastly, the cover 70 encompasses the outside of the glass type front filter 40 and is connected to the case 60.

As discussed above, the related art PDP set includes the glass type front filter 40 for shielding electromagnetic waves and correcting optical characteristics. However, because the glass type front filter 40 includes a glass substrate made from the reinforced glass, which is relatively thick, the thickness and weight of the PDP set were increased, and the cost of manufacture was also increased.

As an attempt to solve the above-described problems, a film type front filter without a glass substrate, as shown in FIG. 5, has been suggested. The film type front filter 65 shown in FIG. 5 includes a color correcting film 68, a NIR blocking film 66, an EMI shielding film 64, and an antireflection coating 62, each being sequentially adhered to an upper plate 15 of the PDP 30.

The antireflection coating 62 prevents incident light rays from outside from reflecting back to the outside. The EMI shielding film 64 absorbs electromagnetic waves generated from the PDP 30 and shields the emission of the electromagnetic waves to outside.

The NIR blocking film 66 absorbs near infrared rays that are generated from the PDP 30 and blocks the emission of the near infrared rays to outside.

The color correcting film 68 contains a color dye to adjust or correct colors and consequently improves color purity.

These films 62, 64, 66, and 68 are adhered to the upper plate 15 of the PDP 30 through an adhesive or glue.

As mentioned before, the black frame undergoes the thermal treatment to be fixed in the film type front filter 65. When the film type front filter 65 is exposed to a high temperature, however, it is often cracked.

For the above reason, manufacturers hesitate to include the black frame for the film type front filter 65.

### SUMMARY OF THE INVENTION

An object of the invention is to solve at least the above problems and/or disadvantages and to provide at least the advantages described hereinafter.

Accordingly, one object of the present invention is to solve the foregoing problems by providing a display panel module having a black panel adequate for a film type front filter, and a manufacturing method thereof.

The foregoing and other objects and advantages are realized by providing a display panel module including: a display panel; a black frame formed on a front surface of the display panel to define an effective screen area; and a front filter formed on the front surface of the display panel on which the black frame is formed, to shield electromagnetic waves and for optical correction.

In an exemplary embodiment of the invention, the front filter is a film type front filter.

In an exemplary embodiment of the invention, the film type front filter includes: an antireflection coating for preventing external light reflection; an EMI (electromagnetic interference) shielding film for shielding electromagnetic waves from the display panel; and an NIR (near infrared rays) blocking film for blocking near infrared rays from the display panel.

In an exemplary embodiment of the invention, the NIR blocking film contains a color dye for correcting colors.

Another aspect of the invention provides a manufacturing method of a display panel module includes the steps of: forming a display panel; forming a black frame on a front surface of the display panel to define an effective screen area; and attaching a film type front filter to the front surface of the display panel on which the black frame is formed.

In an exemplary embodiment of the invention, the black frame is formed by printing black ceramic on the front surface of the display panel and then firing the black ceramic.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a perspective view of a related art three-electrode AC surface discharge plasma display panel (PDP);

FIG. 2 is a schematic perspective view of a PDP set including a PDP of FIG. 1;

FIG. 3 is a cross-sectional view showing a vertical structure of a glass type front filter and PDP of FIG. 2, respectively;

FIG. 4 is a plan view of an effective screen area defined by a black frame illustrated in FIG. 3;

FIG. 5 is a cross-sectional view showing a vertical structure of a PDP to which a related art film type front filter is attached;

FIG. 6 is a cross-sectional view showing a vertical structure of a PDP module having a front filter according to a preferred embodiment of the present invention; and

FIG. 7A to FIG. 7C are cross-sectional views diagrammatically showing a step-by-step procedure for manufacturing a PDP module having a front filter according to a preferred embodiment of the present invention.

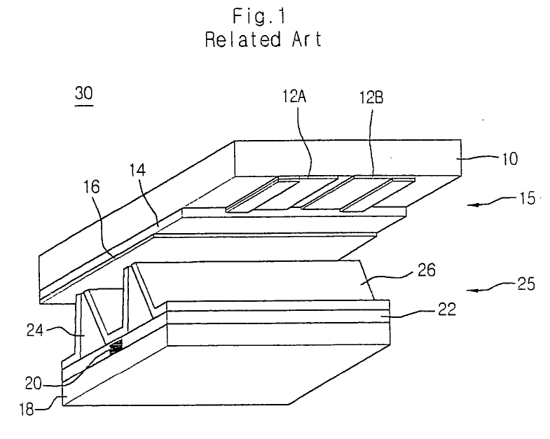

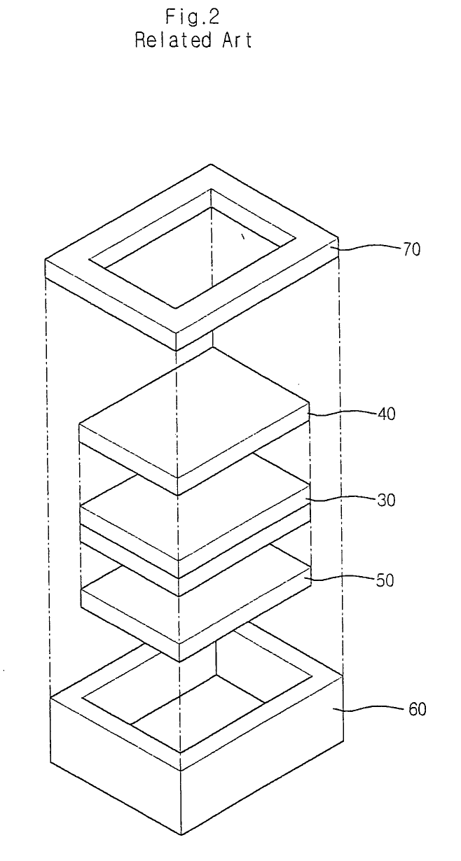

### DETAILED DESCRIPTION OF PREFERRED EMBODIMENTS

The following detailed description will present a display panel module and a manufacturing method thereof according to a preferred embodiment of the invention in reference to the accompanying drawings.

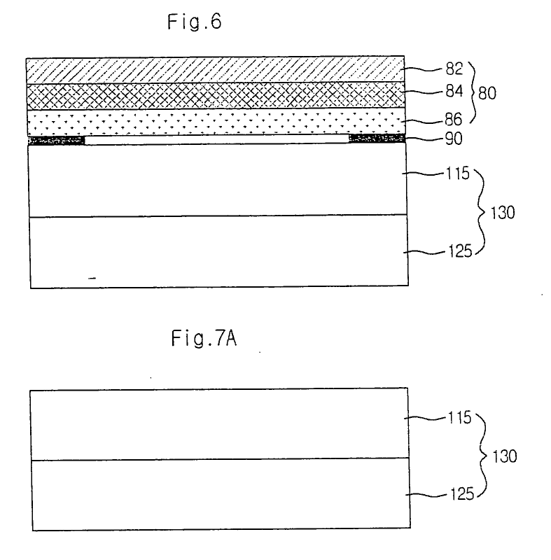

FIG. 6 illustrates a vertical structure of a PDP module having a front filter according to the preferred embodiment of the present invention. The PDP module of FIG. 6 includes a PDP 130 having a black frame 90 at the front, and a film type front filter 80 attached to the top of the black frame 90.

The PDP 130 employs discharge with inactive gases filled in a discharge space between an upper plate 115 and a lower plate 125.

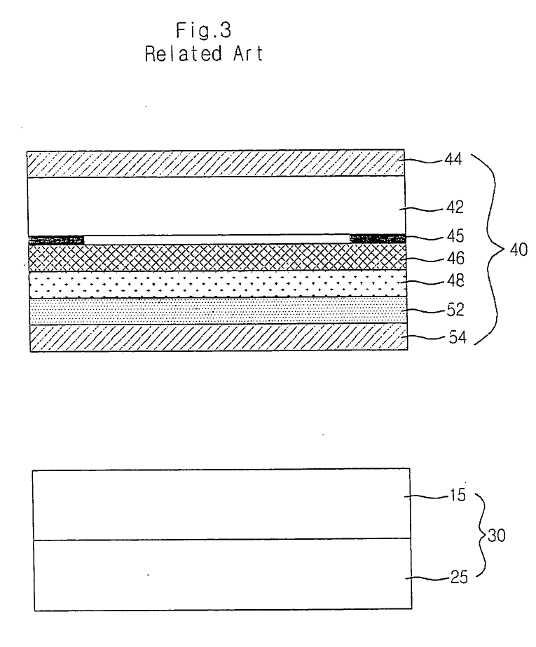

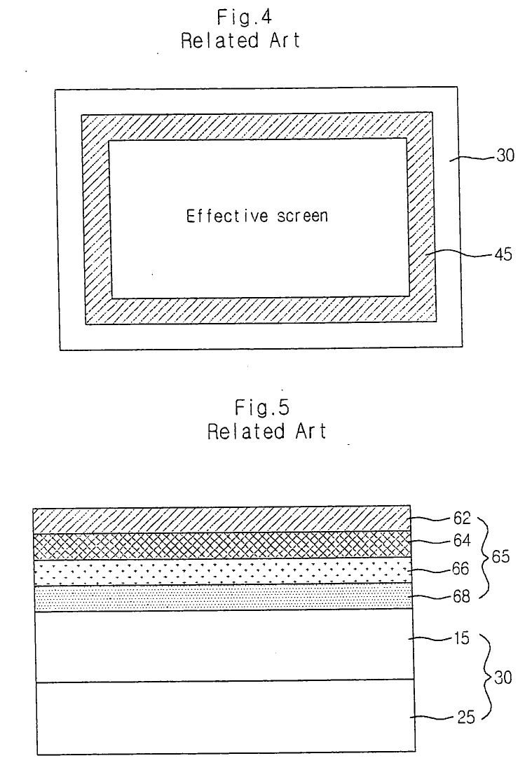

As shown in FIG. 4, the front of the PDP 130 is formed of a black frame 90, which defines an effective screen area and makes the screen outline stood out.

Then a film type front filter 80 is attached to the front surface of the PDP 130 with the black frame 90.

The film type front filter 80 shields electromagnetic waves generated from the PDP 80 towards the front surface, prevents external light reflection, blocks near-infrared rays, and corrects colors. To this end, the film type front filter 80 includes a NIR blocking film 86, an EMI shielding film 84, and an antireflection coating 82.

The NIR blocking film 86 absorbs near infrared rays at a wavelength band of 800-1000 nm that are generated from the PDP 130, and blocks the emission of the near infrared rays to outside. This is how infrared rays (approximately 947 nm) generated from a remote controller are normally input to an infrared ray receiver built in the PDP set. Also, the NIR blocking film 86 contains a near infrared ray absorbent and a color dye for increasing color purity to adjust or correct colors.

The EMI shielding film 84 absorbs electromagnetic waves generated from the PDP 130, and shields the emission of the electromagnetic waves to outside.

The antireflection coating 82 prevents incident light rays from outside reflecting back to the outside and thus, improves contrast effects.

The NIR blocking film 86, the EMI shielding film 84, and the antireflection coating 82 are adhered to each other through an adhesive or glue. The rear surface of the lowest layer, namely the NIR blocking film 86, is adhered to the front surface of the PDP 130 where the black frame 90 is formed.

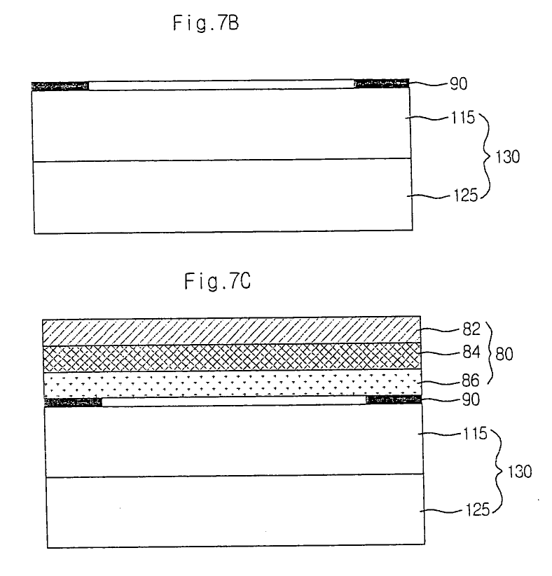

FIG. 7A to FIG. 7C diagrammatically depict a step-by-step procedure for manufacturing a PDP module having a front filter according to a preferred embodiment of the present invention.

First of all, the PDP 130 is prepared by cohering the upper plate 115 and the lower plate 125 together.

Next, black ceramic is printed on the front surface of the PDP 130, the front surface of the upper plate 115 to be more specific, along the outline of the PDP 130, and undergoes a thermal treatment. As a result, the black frame 90 is fixed to the upper plate 115 of the PDP 130, as illustrated in FIG. 7B. In this case, a firing temperature for the black ceramic is in a same range with the firing temperature of the black ceramic for the glass type front filter.

As FIG. 7C illustrates, a separately prepared film type front filter 80 is finally attached to the front surface of the PDP 130 with the black frame 90.

By forming the black frame 90 on the front surface of the PDP 130 and by attaching the film type front filter 80 to the top of the black frame 90, the film type front filter 80 is much less damaged by the thermal treatment on the black frame 90.

As discussed above, the black frame is first formed on the front surface of the upper plate and the film type front filter is attached to the top of the black frame.

Therefore, the present invention's display panel module having the film type front filter and the manufacturing method thereof can be advantageously used for preventing damages (e.g., crack) on the film type front filter caused by the thermal treatment on the black frame.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A display panel module comprising:
a display panel;
a black frame formed on a front surface of the display panel to define an effective screen area; and
a film type front filter on the black frame, to shield electromagnetic waves and for optical correction.

2. The display panel module according to claim 1, wherein the film type front filter does not include a glass substrate.

3. The display panel module according to claim 2, wherein the film type front filter comprises:
a NIR (Near Infrared Rays) blocking film for blocking near infrared rays from the display panel.

4. The display panel module according to claim 3, wherein the NIR blocking film contains a color dye for correcting colors.

5. A manufacturing method of a display panel module, the method comprising:
forming a display panel;
forming a black frame on a front surface of the display panel to define an effective screen area; and
attaching a film type front filter to the black frame.

6. The method according to claim 5, wherein the black frame formation comprising:
printing black ceramic on the front surface of the display panel; and
firing the black ceramic.

7. The display panel module according to claim 3, further comprising an antireflection coating for preventing external light reflection.

8. The display panel module according to claim 3, further comprising an EMI (Electromagnetic Interference) shielding film for shielding electromagnetic waves from the display panel.

9. A display panel module comprising:
a display panel;
a black frame formed on a front surface of the display panel to define an effective screen area; and
a front filter without a glass substrate formed on the black frame, to shield electromagnetic waves and for optical correction.

10. The display panel module according to claim 9, wherein the front filter comprises:
an NIR (Near Infrared Rays) blocking film for blocking near infrared rays from the display panel.

11. The display panel module according to claim 10, wherein the NIR blocking film contains a color dye for correcting colors.

12. The display panel module according to claim 9, further comprising an antireflection coating for preventing external light reflection.

13. The display panel module according to claim 9, further comprising an EMI (Electromagnetic Interference) shielding film for shielding electromagnetic waves from the display panel.

14. The method according to claim 5, wherein the film type front filter is adhered to the front surface of the display by using an adhesive.

15. A manufacturing method of a display panel module, the method comprising:
forming a display panel module;
forming a black frame formed on a front surface of the display panel to define an effective screen area;
forming a film type front filter without a glass substrate; and
attaching the film type front filter to the black frame, to shield electromagnetic waves and for optical correction.

16. The method according to claim 15, wherein the film type front filter is adhered to the front surface of the display by using an adhesive.

17. The method according to claim 15, wherein the black frame formation comprising:
printing black ceramic on the front surface of the display panel; and
firing the black frame.

18. The method according to claim 15, wherein the film type front filter comprises:
an NIR (Near Infrared Rays) blocking film for blocking near infrared rays from the display panel.

19. The method according to claim 18, wherein the NIR blocking film contains a color dye for correcting colors.

20. The method according to claim 18, further comprising an antireflection coating for preventing external light reflection.

21. The method according to claim 18, further comprising an EMI (Electromagnetic Interference) shielding film for shielding electromagnetic waves from the display panel.
